(19) United States
(12) Patent Application Publication
(10) Pub. No.: US 2025/0315394 A1
(43) Pub. Date: Oct. 9, 2025

(54) SECURE, SCALABLE DOORBELL MECHANISM BETWEEN PEERS IN A PCIE FABRIC

(71) Applicant: Sony Interactive Entertainment Inc., Tokyo (JP)

(72) Inventor: NAGARAJAN SUBRAMANIYAN, San Mateo, CA (US)

(21) Appl. No.: 18/630,387

(22) Filed: Apr. 9, 2024

(51) Int. Cl. G06F 13/24; G06F 13/40

(52) U.S. Cl. CPC G06F 13/24; G06F 13/4022; G06F 2213/0026

(57) ABSTRACT

A scalable doorbell mechanism for notifying a peer in a peer-to-peer PCIe fabric, based on application request in addition to an automatic notification of incoming data. The doorbell mechanism does not require any security exposure otherwise exhibited by non-transparent bridging in a PCIe fabric. Doorbells are further enhanced with several configuration options.

### FIELD

The present application relates generally to secure, scalable doorbell mechanisms between peers in a PCIe fabric.

### BACKGROUND

The terms “doorbell” and “doorbell mechanisms” refer to notice messages in a peripheral component interconnect express (PCIe) component architecture between two sides of a non-transparent bridge endpoint, and essentially are a mechanism between the two sides to give notification of an action required. Every doorbell can be specific to event.

As understood herein, existing PCIe fabric peer-to-peer doorbell mechanisms with non-transparent bridging have several disadvantages and shortcomings, including providing for only a limited number of doorbells, undesirable security exposure because there is no direct way to ring a doorbell of a peer unless by directly writing to a remote hardware endpoint, which requires exposing remote system hardware to all peers, and cumbersome assignment of doorbells for a specific use case/application which requires additional steps involving the peers. Moreover, existing doorbells are not tied to other resources (including memory) shared between the two peers and is a separate entity such that a management application must invoke several steps to connect the two resources.

### SUMMARY

Present principles resolve some or all of the above technical challenges with a simple hardware scheme with proper management software hooks to control/configure doorbells. This improves response times and application latencies/complexity for applications using such peer-to-peer PCIe fabric for sharing data.

Accordingly, a method includes identifying a doorbell event in a transmitting peer. The method further includes representing the doorbell event with a zero byte write (ZBW) having a destination address and zero bytes of payload data otherwise. The method includes sending the ZBW from the transmitting peer to a destination peer, and identifying, at the destination peer, a notification based on the ZBW.

In example embodiments the method includes sending the ZBW over a peripheral computer interconnect express (PCIe) fabric.

In some implementations the method may include identifying a write in the transmitting peer, with the write being addressed to a memory window. The method may include generating a doorbell event for the memory window, and writing the doorbell event to a doorbell register on a host side of the transmitting peer. Responsive to writing the doorbell event to the doorbell register, the method may, if desired, map a destination ID associated with the doorbell event to a memory window of the destination peer. Th The method may then include sending the doorbell event to the memory window of the destination peer. In specific embodiments the method can include sending the doorbell event to the destination peer as a regular PCIe write transaction.

In some embodiments the method can include associating the doorbell event with a unique, one-to-one or many-to-one mapping of local system interrupts. In some implementations the method may include mapping a memory window at the destination peer receiving the ZBW to a local doorbell event that is associated with a local interrupt. Responsive to determining that the doorbell event is enabled to interrupt the host, the method may include triggering a local host interrupt.

In another aspect, a device has circuitry configured to translate at least one doorbell at a transmitting peer to an address routed vendor defined message (VDM) using peripheral computer interconnect express (PCIe) transmission layer protocol (TLP), and send the VDM to a remote address of a destination peer to provide a notification to the destination peer.

In another aspect, an apparatus includes at least one transmitting peer, at least one destination peer, and at least one peripheral computer interconnect express (PCIe) fabric communicatively coupling the transmitting peer to the destination peer. The transmitting peer includes circuitry configured for identifying a doorbell event, representing the doorbell event with a zero byte write (ZBW) having a destination address and zero bytes otherwise, and sending the ZBW from the transmitting peer to the destination peer.

The details of the present application, both as to its structure and operation, can be best understood in reference to the accompanying drawings, in which like reference numerals refer to like parts, and in which:

### BRIEF DESCRIPTION OF THE DRAWINGS

FIG. 1 is a block diagram of an example system in accordance with present principles;

FIG. 2 illustrates an example environment;

FIG. 3 illustrates a high level architecture;

FIG. 4 illustrates an example detailed architecture;

FIGS. 5A and 5B illustrate example logic in example flow chart format for operation between two peers;

FIG. 6 illustrates further example logic in example flow chart format;
and

FIG. 7 illustrates an example gaming datacenter.

### DETAILED DESCRIPTION

This disclosure relates generally to computer ecosystems including aspects of consumer electronics (CE) device networks such as but not limited to computer game networks. A system herein may include server and client components which may be connected over a network such that data may be exchanged between the client and server components. The client components may include one or more computing devices including game consoles such as Sony PlayStation® or a game console made by Microsoft or Nintendo or other manufacturer, extended reality (XR) headsets such as virtual reality (VR) headsets, augmented reality (AR) headsets, portable televisions (e.g., smart TVs, Internet-enabled TVs), portable computers such as laptops and tablet computers, and other mobile devices including smart phones and additional examples discussed below. These client devices may operate with a variety of operating environments. For example, some of the client computers may employ, as examples, Linux operating systems, operating systems from Microsoft, or a Unix operating system, or operating systems produced by Apple, Inc., or Google, or a Berkeley Software Distribution or Berkeley Standard Distribution (BSD) OS including descendants of BSD. These operating environments may be used to execute one or more browsing programs, such as a browser made by Microsoft or Google or Mozilla or other browser program that can access websites hosted by the Internet servers discussed below. Also, an operating environment according to present principles may be used to execute one or more computer game programs.

Servers and/or gateways may be used that may include one or more processors executing instructions that configure the servers to receive and transmit data over a network such as the Internet. Or a client and server can be connected over a local intranet or a virtual private network. A server or controller may be instantiated by a game console such as a Sony PlayStation®, a personal computer, etc.

Information may be exchanged over a network between the clients and servers. To this end and for security, servers and/or clients can include firewalls, load balancers, temporary storages, and proxies, and other network infrastructure for reliability and security. One or more servers may form an apparatus that implement methods of providing a secure community such as an online social website or gamer network to network members.

A processor may be a single- or multi-chip processor that can execute logic by means of various lines such as address lines, data lines, and control lines and registers and shift registers. A processor including a digital signal processor (DSP) may be an embodiment of circuitry. A processor system may include one or more processors.

Components included in one embodiment can be used in other embodiments in any appropriate combination. For example, any of the various components described herein and/or depicted in the Figures may be combined, interchanged, or excluded from other embodiments.

“A system having at least one of A, B, and C” (likewise “a system having at least one of A, B, or C” and “a system having at least one of A, B, C”) includes systems that have A alone, B alone, C alone, A and B together, A and C together, B and C together, and/or A, B, and C together.

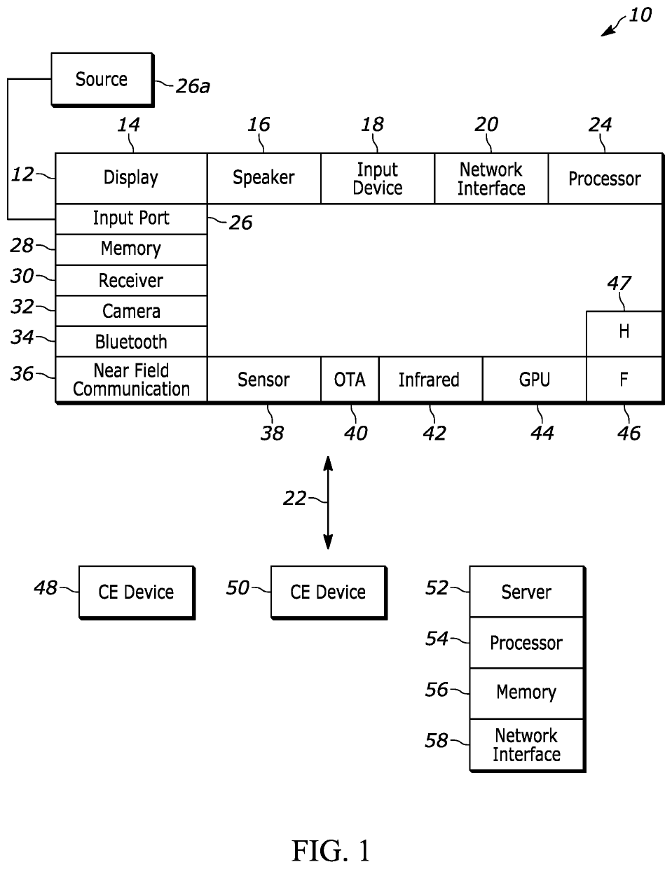

Referring now to FIG. 1, an example system 10 is shown, which may include one or more of the example devices mentioned above and described further below in accordance with present principles. The first of the example devices included in the system 10 is a consumer electronics (CE) device such as an audio video device (AVD) 12 such as but not limited to a theater display system which may be projector-based, or an Internet-enabled TV with a TV tuner (equivalently, set top box controlling a TV). The AVD 12 alternatively may also be a computerized Internet enabled (“smart”) telephone, a tablet computer, a notebook computer, a head-mounted device (HMD) and/or headset such as smart glasses or a VR headset, another wearable computerized device, a computerized Internet-enabled music player, computerized Internet-enabled headphones, a computerized Internet-enabled implantable device such as an implantable skin device, etc. Regardless, it is to be understood that the AVD 12 is configured to undertake present principles (e.g., communicate with other CE devices to undertake present principles, execute the logic described herein, and perform any other functions and/or operations described herein).

Accordingly, to undertake such principles the AVD 12 can be established by some, or all of the components shown. For example, the AVD 12 can include one or more touch-enabled displays 14 that may be implemented by a high definition or ultra-high definition “4K” or higher flat screen. The touch-enabled display(s) 14 may include, for example, a capacitive or resistive touch sensing layer with a grid of electrodes for touch sensing consistent with present principles.

The AVD 12 may also include one or more speakers 16 for outputting audio in accordance with present principles, and at least one additional input device 18 such as an audio receiver/microphone for entering audible commands to the AVD 12 to control the AVD 12. The example AVD 12 may also include one or more network interfaces 20 for communication over at least one network 22 such as the Internet, an WAN, an LAN, etc. under control of one or more processors 24. Thus, the interface 20 may be, without limitation, a Wi-Fi transceiver, which is an example of a wireless computer network interface, such as but not limited to a mesh network transceiver. It is to be understood that the processor 24 controls the AVD 12 to undertake present principles, including the other elements of the AVD 12 described herein such as controlling the display 14 to present images thereon and receiving input therefrom. Furthermore, note the network interface 20 may be a wired or wireless modem or router, or other appropriate interface such as a wireless telephony transceiver, or Wi-Fi transceiver as mentioned above, etc.

In addition to the foregoing, the AVD 12 may also include one or more input and/or output ports 26 such as a high-definition multimedia interface (HDMI) port or a universal serial bus (USB) port to physically connect to another CE device and/or a headphone port to connect headphones to the AVD 12 for presentation of audio from the AVD 12 to a user through the headphones. For example, the input port 26 may be connected via wire or wirelessly to a cable or satellite source 26a of audio video content. Thus, the source 26a may be a separate or integrated set top box, or a satellite receiver. Or the source 26a may be a game console or disk player containing content. The source 26a when implemented as a game console may include some or all of the components described below in relation to the CE device 48.

The AVD 12 may further include one or more computer memories/computer-readable storage media 28 such as disk-based or solid-state storage that are not transitory signals, in some cases embodied in the chassis of the AVD as standalone devices or as a personal video recording device (PVR) or video disk player either internal or external to the chassis of the AVD for playing back AV programs or as removable memory media or the below-described server. Also, in some embodiments, the AVD 12 can include a position or location receiver such as but not limited to a cellphone receiver, GPS receiver and/or altimeter 30 that is configured to receive geographic position information from a satellite or cellphone base station and provide the information to the processor 24 and/or determine an altitude at which the AVD 12 is disposed in conjunction with the processor 24.

Continuing the description of the AVD 12, in some embodiments the AVD 12 may include one or more cameras 32 that may be a thermal imaging camera, a digital camera such as a webcam, an IR sensor, an event-based sensor, and/or a camera integrated into the AVD 12 and controllable by the processor 24 to gather pictures/images and/or video in accordance with present principles. Also included on the AVD 12 may be a Bluetooth® transceiver 34 and other Near Field Communication (NFC) element 36 for communication with other devices using Bluetooth and/or NFC technology, respectively. An example NFC element can be a radio frequency identification (RFID) element.

Further still, the AVD 12 may include one or more auxiliary sensors 38 that provide input to the processor 24. For example, one or more of the auxiliary sensors 38 may include one or more pressure sensors forming a layer of the touch-enabled display 14 itself and may be, without limitation, piezoelectric pressure sensors, capacitive pressure sensors, piezoresistive strain gauges, optical pressure sensors, electromagnetic pressure sensors, etc. Other sensor examples include a pressure sensor, a motion sensor such as an accelerometer, gyroscope, cyclometer, or a magnetic sensor, an infrared (IR) sensor, an optical sensor, a speed and/or cadence sensor, an event-based sensor, a gesture sensor (e.g., for sensing gesture command). The sensor 38 thus may be implemented by one or more motion sensors, such as individual accelerometers, gyroscopes, and magnetometers and/or an inertial measurement unit (IMU) that typically includes a combination of accelerometers, gyroscopes, and magnetometers to determine the location and orientation of the AVD 12 in three dimension or by an event-based sensors such as event detection sensors (EDS). An EDS consistent with the present disclosure provides an output that indicates a change in light intensity sensed by at least one pixel of a light sensing array. For example, if the light sensed by a pixel is decreasing, the output of the EDS may be −1; if it is increasing, the output of the EDS may be a +1. No change in light intensity below a certain threshold may be indicated by an output binary signal of 0.

The AVD 12 may also include an over-the-air TV broadcast port 40 for receiving OTA TV broadcasts providing input to the processor 24. In addition to the foregoing, it is noted that the AVD 12 may also include an infrared (IR) transmitter and/or IR receiver and/or IR transceiver 42 such as an IR data association (IRDA) device. A battery (not shown) may be provided for powering the AVD 12, as may be a kinetic energy harvester that may turn kinetic energy into power to charge the battery and/or power the AVD 12. A graphics processing unit (GPU) 44 and field programmable gated array 46 also may be included. One or more haptics/vibration generators 47 may be provided for generating tactile signals that can be sensed by a person holding or in contact with the device. The haptics generators 47 may thus vibrate all or part of the AVD 12 using an electric motor connected to an off-center and/or off-balanced weight via the motor's rotatable shaft so that the shaft may rotate under control of the motor (which in turn may be controlled by a processor such as the processor 24) to create vibration of various frequencies and/or amplitudes as well as force simulations in various directions.

A light source such as a projector such as an infrared (IR) projector also may be included.

In addition to the AVD 12, the system 10 may include one or more other CE device types. In one example, a first CE device 48 may be a computer game console that can be used to send computer game audio and video to the AVD 12 via commands sent directly to the AVD 12 and/or through the below-described server while a second CE device 50 may include similar components as the first CE device 48. In the example shown, the second CE device 50 may be configured as a computer game controller manipulated by a player or a head-mounted display (HMD) worn by a player. The HMD may include a heads-up transparent or non-transparent display for respectively presenting AR/MR content or VR content (more generally, extended reality (XR) content). The HMD may be configured as a glasses-type display or as a bulkier VR-type display vended by computer game equipment manufacturers.

In the example shown, only two CE devices are shown, it being understood that fewer or greater devices may be used. A device herein may implement some or all of the components shown for the AVD 12. Any of the components shown in the following figures may incorporate some or all of the components shown in the case of the AVD 12.

Now in reference to the afore-mentioned at least one server 52, it includes at least one server processor 54, at least one tangible computer readable storage medium 56 such as disk-based or solid-state storage, and at least one network interface 58 that, under control of the server processor 54, allows for communication with the other illustrated devices over the network 22, and indeed may facilitate communication between servers and client devices in accordance with present principles. Note that the network interface 58 may be, e.g., a wired or wireless modem or router, Wi-Fi transceiver, or other appropriate interface such as, e.g., a wireless telephony transceiver.

Accordingly, in some embodiments the server 52 may be an Internet server or an entire server “farm” and may include and perform “cloud” functions such that the devices of the system 10 may access a “cloud” environment via the server 52 in example embodiments for, e.g., network gaming applications. Or the server 52 may be implemented by one or more game consoles or other computers in the same room as the other devices shown or nearby.

The components shown in the following figures may include some or all components shown in herein. Any user interfaces (UI) described herein may be consolidated and/or expanded, and UI elements may be mixed and matched between UIs.

Present principles may employ various machine learning models, including deep learning models. Machine learning models consistent with present principles may use various algorithms trained in ways that include supervised learning, unsupervised learning, semi-supervised learning, reinforcement learning, feature learning, self-learning, and other forms of learning. Examples of such algorithms, which can be implemented by computer circuitry, include one or more neural networks, such as a convolutional neural network (CNN), a recurrent neural network (RNN), and a type of RNN known as a long short-term memory (LSTM) network. Generative pre-trained transformers (GPTT) also may be used. Support vector machines (SVM) and Bayesian networks also may be considered to be examples of machine learning models. In addition to the types of networks set forth above, models herein may be implemented by classifiers.

As understood herein, performing machine learning may therefore involve accessing and then training a model on training data to enable the model to process further data to make inferences. An artificial neural network/artificial intelligence model trained through machine learning may thus include an input layer, an output layer, and multiple hidden layers in between that are configured and weighted to make inferences about an appropriate output.

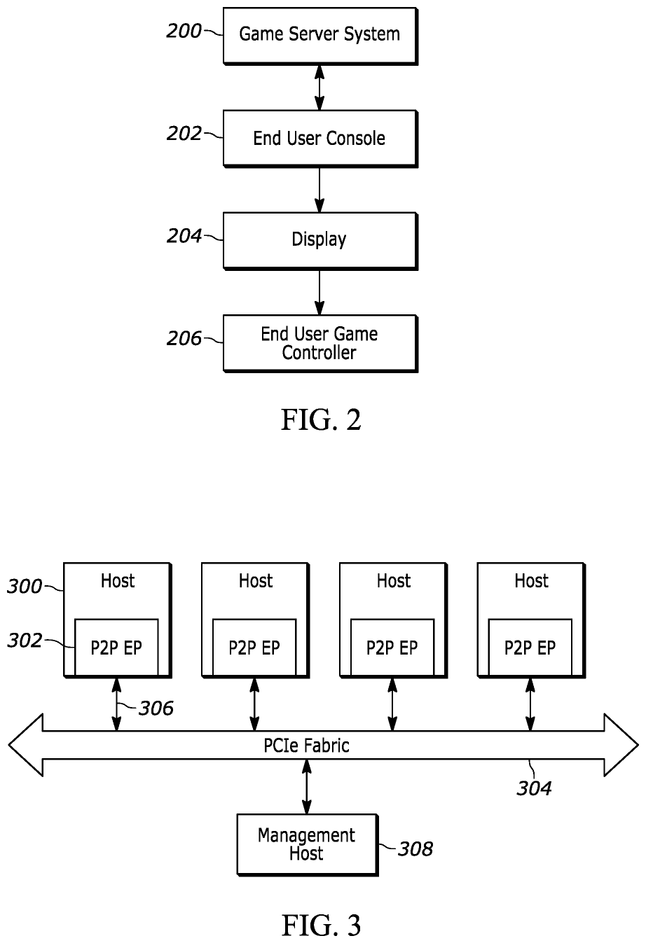

FIG. 2 illustrates an example environment in which present principles may be used. A computer simulation server system 200 such as a computer game server or servers communicates with one or more end user game consoles 202 and/or displays 204 to present computer simulations such as computer games on the display, if desired under control of a player manipulating an end user computer game controller 206. Present principles may be used to implement the server system 200.

Note that present principles apply to the server system 200, which may employ racks of computer game consoles that use substantially the same hardware and software as end user consoles.

Refer now to FIG. 3, which illustrates a rack level network of computer servers, referred to herein as “hosts” 300, each having a respective peripheral computer interconnect express (PCIe) messaging direct memory access (DMA) endpoint 302 connected to a PCIe fabric 304 via respective PCIe links 306. The links 306 may appear as non-transparent bridges to be enumerated, configured and managed by a management host 308 connected to the same PCIe fabric 304 as are the hosts 300.

Present principles are based on a rack/row level PCIe fabric with each host connecting to the fabric using a non-transparent bridge. Each host communicates with another host using the memory windows shared by the non-transparent bridge, configured and set up by a management entity such as the management host 308.

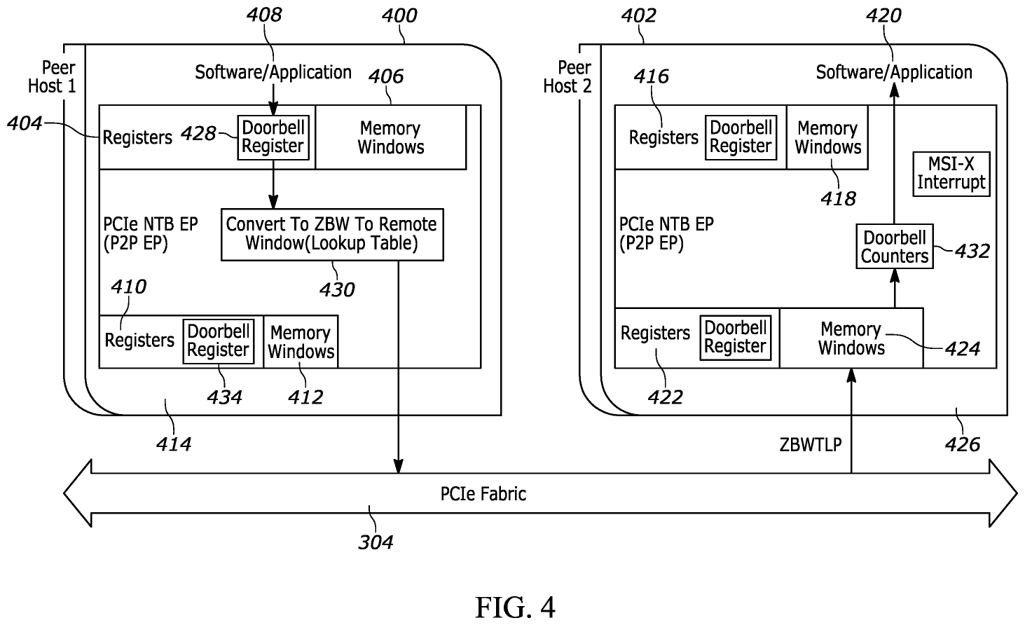

FIG. 4 illustrates details of an endpoint 302 in FIG. 3. A transmitting host 400 seeks to send a doorbell message to a destination host 402. The transmitting host 400 includes registers 404 and memory windows 406 on the software/application side 408 and registers 410 and memory windows 412 on its PCIe fabric side 414. Similarly, the destination host 402 includes registers 416 and memory windows 418 on the software/application side 420 and registers 422 and memory windows 424 on its PCIe fabric side 426.

Absent present principles, while it is preferable to maintain peers isolated from each other except for sending and receiving messages, doorbells expose the hardware of the other party in the communication. Further, doorbells cannot be configured easily nor are they easily scalable, requiring using a single doorbell multiple times, raising bandwidth and latency issues.

To address these issues, the transmitting host 400 includes a doorbell register 428. The doorbell register 428 supplies a destination context by enabling a component 430 such as a processor to create and send a zero byte write (ZBW) through the fabric 304 to the fabric side memory windows 424 of the destination peer 402. A doorbell counter 432 in the destination peer maintains a list of received ZBWs (effectively, doorbells that have been received). Also, each peer may include doorbell registers 434 on the fabric side in addition to the doorbell registers 428 on the software side.

The ZBW functions as a notification to the destination peer 402. Any write to a memory window of 402 also triggers a doorbell event (and update to doorbell counters 432). In addition to that, if a transmitting application in 400 wants to send a specific doorbell notification to 402, it uses the doorbell register 428 to trigger the hardware to send a ZBW to the memory window 402. When the memory window 402 receives this ZBW it converts it to a doorbell counter event (to the doorbell counter 432) which then maps to a local interrupt to the application/software on 402.

It is to be noted that the doorbell register 434 in FIG. 4 is not used for peer to peer doorbell mechanism, as the intent and purpose of present principles is to not have to know about the hardware registers/interfaces of the other side from one peer and so a peer can't write directly to another peer's hardware registers. A management host owns the bottom PCIe interface (410), while the host 300 owns the 404 interface. The ZBW doorbells through the doorbell registers are between one host 300 and another host 300.

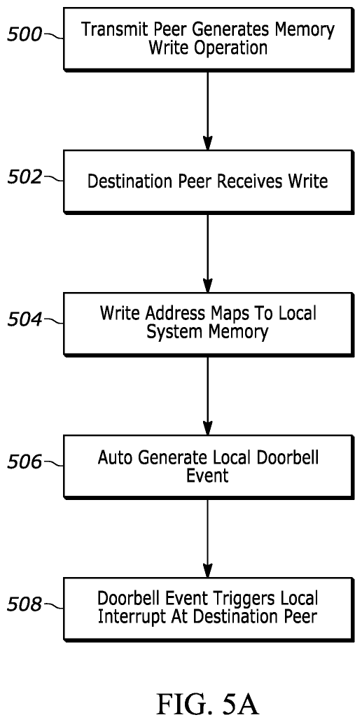

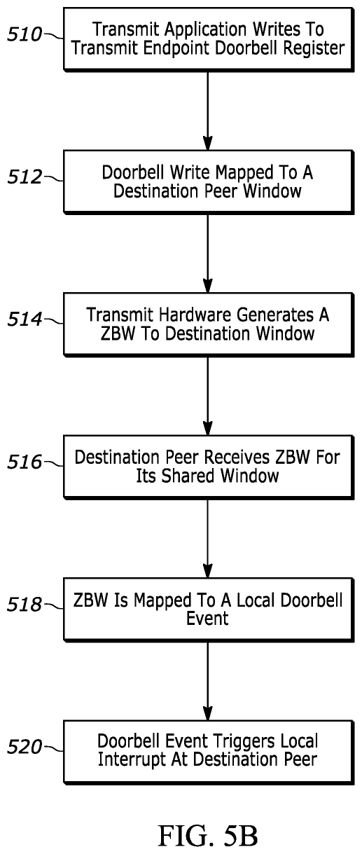

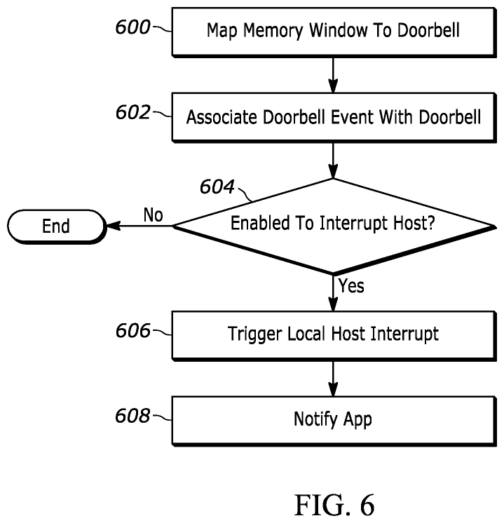

Refer now to FIG. 5. Doorbells may be automatically generated (FIG. 5A) or by an application (FIG. 5B).

Commencing at state 500 in FIG. 5A, A transmitting peer generates a memory write operation, which is received at state 502 by the destination peer. Moving to state 504, a write address is mapped to a local system memory of the destination peer. State 506 then indicates that a local doorbell event is automatically generated by the destination peer. Proceeding to state 508, the doorbell event triggers a local interrupt at the destination peer.

Commencing at state 510 in FIG. 5B, an application executing at the transmitting peer writes to a transmit endpoint doorbell register. Proceeding to state 512, a doorbell write is mapped to a destination peer memory window. State 514 indicates that hardware at the transmitting peer generates a ZBW to the destination memory window, while state 516 indicates that the destination peer receives the doorbell write for its shared window.

Note that the registers 404, 428 in FIG. 4 constitute a doorbell register. At the end of writing data to a destination peer's memory window, it may be desirable for the transmitting peer to generate a notification to the destination peer (which may be done in software fi desired) to precipitate an immediate response/action at the destination peer. To this end, the transmitting peer can write a single word to the doorbell register 428. In an example non-limiting embodiment, the word may be the identification of the destination peer or simply the window number of the destination peer, or more generally, a system ID given to each peer.

Proceeding from state 516 to state 518, the ZBW is mapped to a local doorbell event at the destination peer. At state 520 the doorbell event triggers an interrupt at the destination peer.

FIG. 6 takes up the logic of processing by the destination peer. Commencing at state 600, the hardware of the destination peer 402, on receiving this zero byte write for its memory window, maps this window to the correct local doorbell using the fabric side doorbell register 434 of the destination peer 402, posting a doorbell event to that doorbell at state 602 (essentially associating a specific type of doorbell event with the doorbell). If it is determined at state 604 that the doorbell is enabled to interrupt the host, the logic moves to state 606 to use the event to trigger a local host interrupt for that doorbell, notifying the remote application at state 608.

In an alternative embodiment, instead of using ZBW, the doorbell register 428 on the software side of the transmitting peer can be translated or converted at 430 in FIG. 4 to an address routed vendor defined message (VDM) using PCIe transmission layer protocol (TLP) to the remote peer address. The destination peer captures/terminates the VDM and maps the destination address to a local doorbell.

Present principles provide for security improvements including dispensing with the need to expose/share hardware register space to all other hosts in a PCIe fabric, and dispensing with the need to know any details about the remote peer, other than having a window shared with that peer (having a memory window connection with that peer). Moreover, all the transactions for a doorbell are initiated locally and only standard, valid PCIe packets are exchanged between hosts. No harm or side effects result from the destination peer not supporting present principles.

Window segments 424 and doorbell counters 432 at the destination peer may be equal number so that the memory segment index and the corresponding doorbell counter array index can be the same. In this way, the ZBW packet with the destination address can be processed to identify its segment index (containing memory window), and then that index can be used to access the doorbell counter 432.

Doorbell counters can be configurable with an associated MSI-X, interrupt moderation parameters (count and time between), and an up or down counter with a timer. A doorbell event is one that updates this doorbell counter 432. If the counter update satisfies the moderation parameters and there is an associated MSI-x interrupt configured, then the interrupt will trigger.

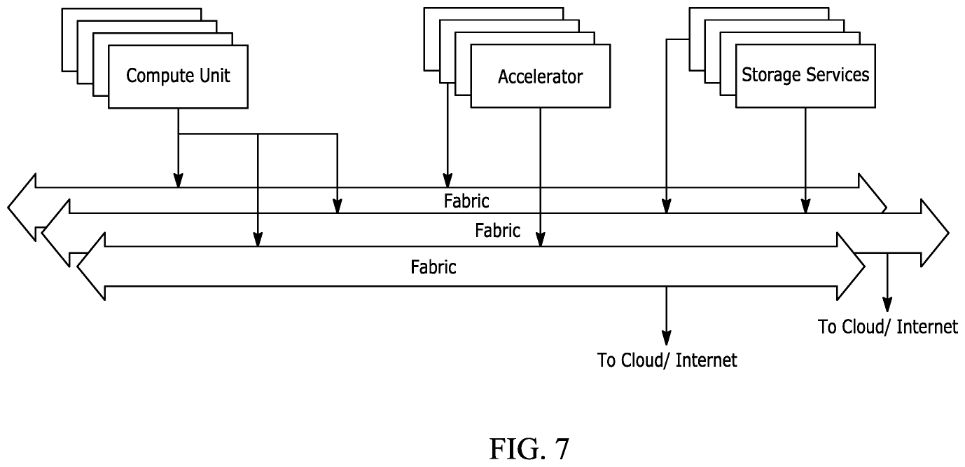

FIG. 7 illustrates an example gaming data center. Each rack of servers includes compute servers, accelerator units (GPUs, DPUs, FPGAs, Video processing, AI inference/ML hardware), and storage services/servers. All these are connected by multiple fabrics (one or two or three, typically; as an example, one ethernet fabric, one PCIe fabric, one storage networking fabric), and most fabrics connect multiple racks and even connect to outside world through internet.

While the particular embodiments are herein shown and described in detail, it is to be understood that the subject matter which is encompassed by the present invention is limited only by the claims.

What is claimed is:

1. A method comprising:
identifying a doorbell event in a transmitting peer;
representing the doorbell event with a zero byte write (ZBW) having a destination address and zero bytes otherwise;
sending the ZBW from the transmitting peer to a destination peer; and
identifying, at the destination peer, a notification based on the ZBW.

2. The method of claim 1, comprising:
identifying a doorbell register write in the transmitting peer, the write being addressed to a memory window; and
generating the ZBW to the destination peer window.

3. The method of claim 2, comprising sending the ZBW over a peripheral computer interconnect express (PCIe) fabric.

4. The method of claim 1, comprising associating the doorbell event with a unique, one-to-one or many-to-one mapping of local system interrupts.

5. The method of claim 1, comprising:
mapping a memory window at the destination peer receiving the ZBW to a local doorbell event; and
posting the doorbell event to a dorrbell counter.

6. The method of claim 5, comprising:
responsive to determining that the doorbell event is enabled to interrupt the host, triggering a local host interrupt.

7. A device comprising:
circuitry configured to:
translate at least one doorbell at a transmitting peer to an address routed vendor defined message (VDM) using peripheral computer interconnect express (PCIe) transmission layer protocol (TLP); and
send the VDM to a remote address of a destination peer to provide a notification to the destination peer.

8. The device of claim 7, wherein the device is implemented in the transmitting peer.

9. The device of claim 7, comprising the destination peer, the destination peer comprising circuitry configured to capture the VDM and map the destination address to a local doorbell.

10. The device of claim 7, wherein the circuitry comprises at least one processor system.

11. An apparatus, comprising:
at least one transmitting peer;
at least one destination peer;
at least one peripheral computer interconnect express (PCIe) fabric communicatively coupling the transmitting peer to the destination peer;
the transmitting peer comprising circuitry configured for:
identifying a doorbell event;
representing the doorbell event with a zero byte write (ZBW) having a destination address and zero bytes otherwise; and
sending the ZBW from the transmitting peer to the destination peer.

12. The apparatus of claim 11, wherein the destination peer comprises circuitry configured for:
identifying a notification based on the ZBW.

13. The apparatus of claim 11, wherein the circuitry of the transmitting peer is configured for:
sending the ZBW over the PCIe fabric.

14. The apparatus of claim 11, wherein the circuitry of the transmitting peer is configured for:
identifying a write, the write being addressed to a memory window; and
generating a doorbell event for the memory window.

15. The apparatus of claim 14, wherein the circuitry of the transmitting peer is configured for:
responsive to writing the doorbell event to s doorbell register, mapping a destination ID associated with the doorbell event to a memory window of the destination peer, the memory window being shared with the transmitting peer; and
sending the doorbell event to the memory window of the destination peer.

16. The apparatus of claim 11, wherein the circuitry of the transmitting peer is configured for:
sending the doorbell event to the destination peer as a regular PCIe write transaction.

17. The apparatus of claim 11, wherein the circuitry of the transmitting peer is configured for:
associating the doorbell event with a unique, one-to-one or many-to-one mapping of local system interrupts.

18. The apparatus of claim 11, comprising circuitry of the destination peer configured for:
mapping a memory window at the destination peer receiving the ZBW to a local doorbell event.

19. The apparatus of claim 18, wherein the circuitry of the destination peer is configured for:
responsive to determining that the doorbell event is enabled to interrupt the host, triggering a local host interrupt.
